(19) United States
(12) Patent Application Publication
(10) Pub. No.: US 2020/0386364 A1
(43) Pub. Date: Dec. 10, 2020

(54) DISPLAYS HAVING DISPLAY ELEMENTS WITH ROTATABLE COMPONENTS

(71) Applicant: Hewlett-Packard Development Company, L.P., Spring, TX (US)

(72) Inventors: Kuan-Ting Wu, Taipei City (TW); Wei-Chung Chen, Taipei City (TW); Cheng-Hua Yu, Taipei City (TW)

(73) Assignee: Hewlett-Packard Development Company, L.P., Spring, TX (US)

(21) Appl. No.: 16/959,164

(22) PCT Filed: Feb. 23, 2018
(86) PCT No.: PCT/US2018/019453

§ 371 Date: Jun. 30, 2020

(51) Int. Cl. F16M 11/10; G09F 9/302; G06F 1/16; G06F 3/14

(52) U.S. Cl. CPC F16M 11/105; G06F 3/1423; G06F 1/1607; G09F 9/3023

(57) ABSTRACT

Examples of a display element corresponding to a pixel of a display, are described. In one example, the display element may include a rotatable component. The rotatable component may be provided with a first sub-element and a second sub-element. The first sub-element and the second sub-element are such that they, respectively, have different type of display properties.

### BACKGROUND

Flat-panel and similar electronic displays (hereinafter referred to as displays) are used in variety of electronic devices. Such electronic devices may include consumer electronic devices, personal computing devices, and mobile communication devices. The displays, themselves, may be either integrated within the housing of such electronic devices, or may be implemented as stand-alone devices (e.g., monitors) communicatively coupled to the electronic devices. Such displays may offer a variety of attributes, such as size, form factor, and power consumption, and may be used for performing a variety of functions.

### BRI EF DESCRIPTION OF THE DRAWINGS

The following detailed description references the drawings, wherein:

FIG. 1 is a block diagram of an example electronic display;

FIG. 2 is a block diagram of an electronic device with an example electronic display;

FIG. 3 is a block diagram of an electronic device as per an example of the present subject matter;

FIGS. 4-5 are diagrams depicting various stages of operation of an example display element;

FIG. 6 is a block diagram of an example visual output display for viewing visual content in various viewing angles; and

FIG. 7 is a block diagram of another example visual output display for viewing visual content in various viewing angles.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Displays with a flat-panel profile may be used in a variety of electronic devices. Such devices may, in turn, be used for a variety of end applications. Any flat panel display may include a certain type of pixels which may be arranged in an array across the dimensions of the display. Such pixels may possess specific display properties. In some cases, an end application may be tied to the type of the pixel. Considering that any display may include pixels having only a certain type of display property, it may be possible that a display having pixels with a certain type of display property may not be used to render content which may require another display property. As a result, displays with certain types of pixels may be more suitable for an end application as compared to displays with pixels with a different type of display property.

For example, the displays may be broadly categorized into at least two categories based on a rate at which any image being rendered is refreshed, namely volatile displays and static displays. Volatile displays may operate by emitting light to display and present visual content according to an input signal. Volatile displays further rely on a continuous electrical power for rendering visual content. On the other hand, static displays may rely on reflection or transmission of light to display and maintain the rendering of the visual content. Static displays do not utilize electrical power for maintaining the rendered content.

Volatile displays are usually used in end-applications which involve higher refresh rates in devices, such as mobile devices, televisions, and computer displays. Higher refresh rates may be used for end-applications which render visual content that is dynamic, i.e., visual content may change rapidly between frames. For example, rendering video-based visual content is commonly performed on displays with higher refresh rates. Volatile displays utilize electrical power for rendering and refreshing visual content being displayed. Examples of volatile displays include, but are not limited to, liquid crystal displays (LCD), light-emitting diode (LED) based displays, and the like.

Static displays, on the other hand, may be used for end-applications which render content that is either static, or content that may be refreshed at a lower rate (i.e., lower when considered with respect to the high refresh rates). For example, static images, text or pages of an electronic book being rendered on an electronic book reader need not be refreshed when assimilating such content. For such displays, the electrical power is utilized when refreshing or changing the visual content. If the visual content remains unchanged, static displays may not consume electrical power. Examples of such static displays include, but are not limited to, electrophoretic displays (EPD), and interferometric modulator displays (IMOD).

The power utilization of volatile and static displays is different. As described, volatile displays rely on a persistent supply of electrical power; on the other hand, static displays rely on electrical power only when the visual content being rendered is to be changed or refreshed. Consequently, volatile displays utilize more electrical power, as compared to static displays. Although devices with static displays consume less power, devices employing static displays do not offer high refresh rate, and to that extent may not be suitable for end-applications which involve displaying content that may require high refresh rates.

In certain cases, displays may be such that they have a narrow angle of viewing. Generally, content being rendered on displays may be visible from a number of positions with respect to the display. In some cases, content rendered on such displays may be visible from a lesser number of positions. Such displays may be used for rendering content that is to be kept private, and is not to be visible for viewing by any other individual who may be in proximity of the display, other than the user.

Electronic devices commonly have a single display. For example, the electronic devices may either be provided with a volatile display or a static display. For private viewing, the display may only render content visible from a limited number of positions and may not be used if the content is not to be kept private. Volatile displays are generally associated with high refresh rates, thus making such displays suitable for fast moving visual content such as a video. Static displays on the other hand are associated with low refresh rates making them suitable for end-applications, such as reading text and viewing images.

Electronic devices, such as mobile phones or tablet computers, may be used for a wide variety of end-applications, such as displaying video, content, viewing images, messaging, and reading text. However, not all end-applications, particularly applications involved in displaying static content, utilize high refresh rates. For example, end-applications such as displaying video content may utilize high refresh rates; but on the other hand, end-applications such as reading an electronic book or any other static textual content may not utilize high refresh rates of the volatile display. In any case, the volatile display may be powered ON irrespective of the end-application which is being performed by the user. As a result, the amount of power consumed for powering the display for end-applications not employing high refresh rates remains unchanged (i.e., the display consumes just as much power rendering low refresh rate content as it does for high refresh rate content). Similarly, devices with displays for private viewing may not be capable of rendering content which may not be for private viewing. It should be noted that other possible modes may be present as well. In any of such cases, it should be noted that displays may only render content in a single mode.

A display, and an electronic device with such a display for displaying visual content in different modes, are described. The display includes a plurality of display elements positioned beneath or behind a screen of the display. A display element corresponds to a pixel of the display. The display elements may be arranged in a two-dimensional array extending in a plane beneath the screen of the display. Each display element is composed of a rotatable component. The rotatable component may rotate about an axis which is parallel to a plane along which the display of the electronic device extends. The rotatable component may further be coupled to, or integrated with, an electric motor which rotates the rotatable component.

Continuing with the display element, the rotatable component is further provided with a first sub-element and a second sub-element. The sub-elements may be arranged on the rotatable component such that the sub-elements are angularly displaced (i.e., angularly spaced apart from each other) with respect to each other. Since the sub-elements are angularly displaced, rotation of the rotatable component positions one of the sub-elements to face the screen. In one example, the first sub-element may be located diametrically opposite to the second sub-element.

The first sub-element and the second sub-element, respectively, correspond to pixel elements having different display properties. Example of such display properties include, but are not limited to, a refresh rate. The refresh rate may be a high-refresh rate or a low-refresh rate. In such a case, the first sub-element may be a pixel element of a volatile display, capable of displaying visual content using high refresh rates. Furthermore, the second sub-element may correspond to a pixel element of a static display capable of displaying visual content using low refresh rates.

In operation, a display attribute corresponding to the visual content, being rendered on the display is determined. Depending on the display attribute, control instructions for rotating the rotatable component are generated. The rotatable component is so rotated, such that one of the first sub-element and the second sub-element is directed towards the screen. For example, the display attribute may indicate whether the visual content being rendered is static or dynamic. On determining that the visual content is dynamic, the rotatable component is rotated such that the first sub-element is directed towards the screen of the display. Conversely, if it is determined that the visual content is static, the rotatable component is rotated such that the second sub-element is directed towards the screen.

Depending on whether the content is dynamic or static, the respective first sub-elements and the second sub-elements, of each of the plurality of display elements may be directed towards the screen of the display. As would be understood from this example, the display may render dynamic visual content using high refresh rates, and static visual content using low refresh rates. As a result, the display of the electronic device may render content using high refresh rates and low refresh rates, depending on the end-application for which the electronic device is being used. Since the second sub-elements utilize less electrical power for operating, the overall power consumed by the electronic device is reduced.

It may be noted that the examples for the display properties are illustrative. Other examples of such similar display properties may also be utilized without deviating from the scope of the present subject matter. Correspondingly the above description has been provided considering the first sub-element and the second sub-element, the display may further include additional sub-elements without deviating from the scope of the present subject matter to cover other types of display properties. For example, the display property may further include modes corresponding to varying angles of viewing. Such angles of viewing provide varying levels of privacy to a user, for viewing content on the screen of their respective electronic device. Various combinations of the example display properties may be implemented with an electronic device without deviating from the scope of the present subject matter.

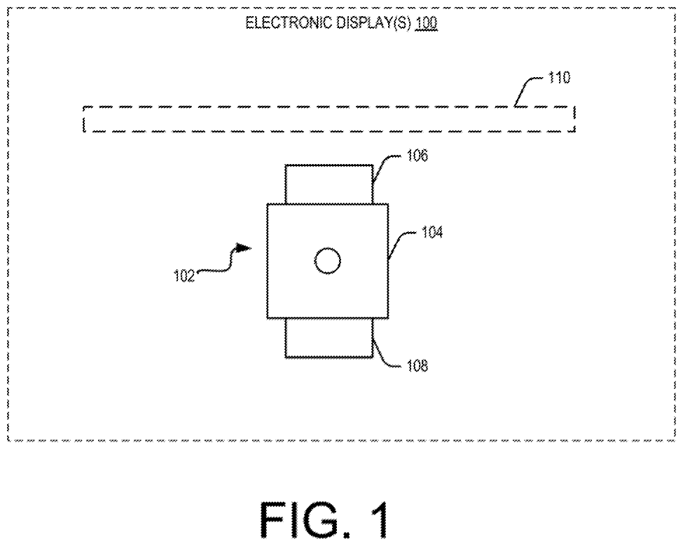

The above-mentioned aspects are further described in detail in conjunction with FIGS. 1-7. The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

FIG. 1 illustrates an example an electronic display 100. The electronic display(s) 100 (hereinafter referred to as display(s) 100). The display(s) 100 may include a plurality of display element(s) 102. The display element(s) 102 is such that it corresponds to a pixel of the display(s) 100. The display element(s) 102, in turn, further includes a rotatable component 104. The rotatable component 104 is rotatable about an axis (not shown in FIG. 1).

In one example, the rotatable component 104 may further include a first sub-element 106 and a second sub-element 108. The first sub-element 106 and the second sub-element 108 are such that they each possess different display properties. In operation, the rotatable component 104 may be rotated such that one of the first sub-element 106 and the second sub-element 108 may be positioned to face screen 110 for rendering visual content. The rotation of the rotatable component 104 may be affected through a microelectromechanical-based drive (not shown in FIG. 1). The axis about which the rotatable component 104 is to rotate is such that it is parallel to the screen 110. As examples, the different display properties may include, but are not limited to, refresh rates and privacy modes.

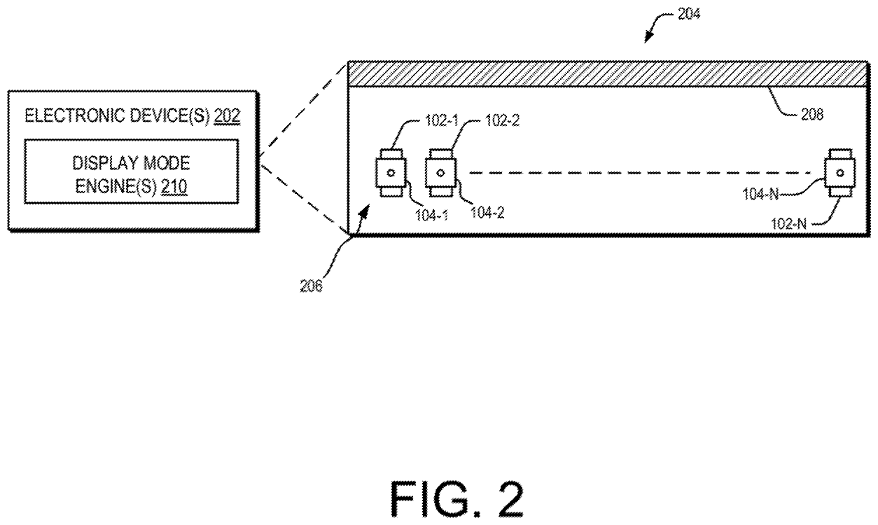

FIG. 2 illustrates an example electronic device(s) 202 which includes an example display, such as the display(s) 100. The electronic device(s) 202 may be considered as any processor enabled device which performs a variety of functions. An example of such an electronic device(s) 202 includes, but is not limited to, desktop computers, laptops and portable computers. The present approaches may also be implemented in other types of electronic device(s) 202 with displays without deviating from the scope of the present subject matter. The electronic device(s) 202 may be either a standalone device or in communication with other computing devices (not shown in FIG. 2) over a communication network.

The electronic device(s) 202 may further be communicatively coupled with a display(s) 204. The display(s) 204 may be similar to the display(s) 100 (as illustrated in FIG. 1). The display(s) 204 may be either integrated within the electronic device(s) 202 or may be connected through various wired or wireless means. The display(s) 204 may further include an array 206 of display elements, such as the display element(s) 102-1, 102-2, . . . , 102-n. The array 206 of the display element(s) 102 may, in one example, extend in a plane across the dimensions of the display(s) 204. The display element(s) 102 may be housed within a housing of the display(s) 204. The housing (not shown in FIG. 2) may enclose the internal circuitry of the display(s) 204. A side of the housing may further include a display screen 208. The display screen 208 may be used for viewing visual content being rendered by the display element(s) 102. In constructions, the array 206 of display element(s) 102 may be positioned beneath the display screen 208.

Each display element(s) 102 may further include a rotatable component, such as rotatable component 104. The rotatable component 104 may be rotatable about an axis which is parallel to the plane in which the display screen 208 extends. The rotatable component 104 is further provided with sub-elements, such as a first sub-element 106 and a second sub-element 108. The first sub-element 106 and the second sub-element 108 are such that they have different display properties. Examples of such display properties include, but is not limited to, refresh rates. In such an example, one of the first sub-element 106 and the second sub-element 108 may have a high refresh rate, while the other may have a low refresh rate. Other examples of different types of display properties may also be implemented without deviating from the scope of the present subject matter.

The electronic device(s) 202 on the other hand, may further include a display mode engine(s) 210. The display mode engine(s) 210 affects rotation of the rotatable component 104. In one example, the display mode engine(s) 210 may generate control instructions, which when executed may affect the rotation of the rotatable component 104. The rotation of the rotatable component 104 may be based on a display attribute. A display attribute may be considered as any property or attribute of visual content being rendered. The display attribute, in an example, may specify a variety of parameters which may be utilized for rendering the visual content, say onto the display(s) 204. As an instance, the display attribute of a visual content may indicate that the visual content is to be rendered with a certain refresh rate. For example, where the visual content is a video stream, the display attribute may indicate a value of refresh considered as a high refresh rate. In case certain other cases, the display properties may specify low refresh rates for the visual content to be rendered.

In operation, the display mode engine(s) 210 may obtain the display attribute. On determining that the display attribute to be compatible with the display property of one of the first sub-element 106 and the second sub-element 108, the display mode engine(s) 210 may rotate the display element(s) 102 such that the appropriate sub-element is positioned towards the display screen 208. The appropriate sub-element, i.e., one of the first sub-element 106 and the second sub-element 108, may be used for rendering the visual content. In this manner, depending on the visual content which is to be rendered, the appropriate one of the first sub-element 106 and the second sub-element 108, for each of the display element(s) 102 may be positioned accordingly. In this manner, the sub-element appropriately suited for rendering visual content may be utilized. This may result in various functional advantages. For example, if the visual content as such is to be rendered using a low refresh rate, one of the sub-elements, say the second sub-element 108 may be utilized for rendering such visual content. Since the power consumption for rendering visual content using low refresh rate is low, the effective power consumed by the electronic device(s) 202 would be less. These and other aspects of the present subject matter are further explained in the conjunction with subsequent figures.

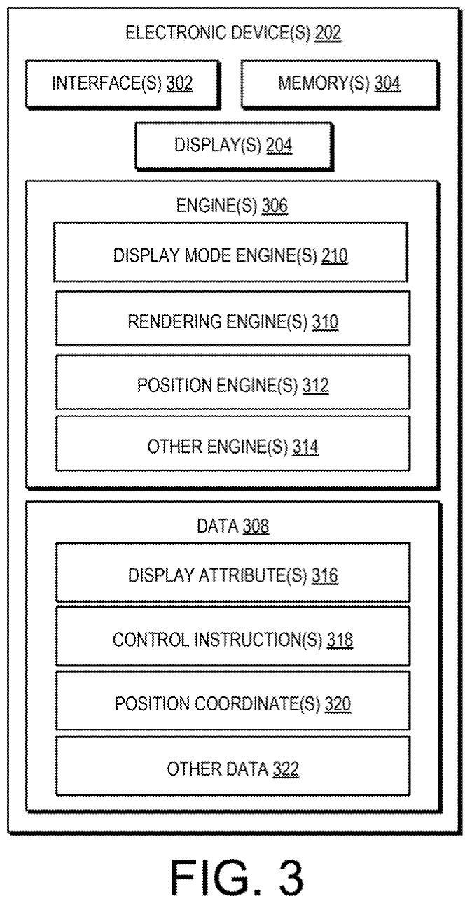

FIG. 3 illustrates a block diagram of electronic device(s) 202 with display (e.g., display(s) 204), as per another example. The electronic device(s) 202 may be implemented as a standalone computing system communicatively connected through a network to other devices (not shown in FIG. 3). The electronic device(s) 202 includes interface(s) 302 and memory 304. The interface(s) 302 may include a variety of interfaces, for example, interfaces for data input and output devices, referred to as I/O devices, storage devices, network devices, and the like. The interface(s) 302 facilitate communication between the electronic device(s) 202 and various computing devices connected in a networked environment. The interface(s) 302 may also be used to communicate signals corresponding to the visual content to the display, such as the display(s) 204.

The memory 304 may store computer-readable instructions, which may be fetched and executed to set a system state as one of wakeable through a trigger and non-wakeable. The memory 304 may include any non-transitory computer-readable medium including, for example, volatile memory such as RAM, or non-volatile memory such as EPROM, flash memory, and the like. The electronic device(s) 202 further includes engine(s) 306 and data 308.

The engine(s) 306 may be implemented as a combination of hardware and programming (for example, programmable instructions) to implement certain functionalities of the engine(s) 306. In examples described herein, such combinations of hardware and programming may be implemented in several different ways. For example, the programming for the engine(s) 306 may be processor executable instructions stored on a non-transitory machine-readable storage medium and the hardware for the engine(s) 306 may include a processing resource (for example, ether a single processor or a combination of multiple processors), to execute such instructions. In the present examples, the machine-readable storage medium may store instructions that, when executed by the processing resource, implement engine(s) 306. In such examples, the electronic device(s) 202 may include the machine-readable storage medium storing the instructions and the processing resource to execute the instructions, or the machine-readable storage medium may be separate but accessible to electronic device(s) 202 and the processing resource. In other examples, engine(s) 306 may be implemented by electronic circuitry.

The data 308 includes data that is either stored or generated as a result of functionalities implemented by any of the engine(s) 306. In an example, the engine(s) 306 include the display mode engine(s) 210, rendering engine(s) 310, position engine(s) 312, and other engine(s) 314. The other engine(s) 314 may implement functionalities that supplement applications or functions performed by the electronic device(s) 202 or engine(s) 306. Further, the data 308 may include display attribute(s) 316, control instruction(s) 318, position coordinate(s) 320 and other data 322.

The electronic device(s) 202 may further include a display, such as the display(s) 204. The display(s) 204 may be either integrated with the circuitry of the electronic device(s) 202 (such as in case of mobile phones, and tablet computing devices), or may be connected to the electronic device(s) 202 through a connecting medium. The display(s) 204 may receive signals corresponding to the visual content from the electronic device(s) 202. The signals may be subsequently processed for rendering the visual content onto the display(s) 204. Signals corresponding to the visual content transmitted to the display(s) 204 may be communicated over a plurality of interconnects. The interconnect may communicate such signals to the rendering engine(s) 310. The rendering engine(s) 310 on receiving such signals may generate signals to activate or illuminate selective one or multiple display element(s) 102, for rendering the content. The rendering engine(s) 310 may communicate with each of the display element(s) 102 over the interconnects. It is to be noted that the communication and/or connection between any of the components may be implemented through other mechanisms without deviating from the scope of the present subject matter.

As discussed in conjunction with FIG. 2, the display(s) 204 further comprises an array 206 of display element(s) 102. The display element(s) 102 may further include a rotatable component 104, onto which the first sub-element 106 and the second sub-element 108 are provided. The array 206 is such that it extends along the display screen 208. In one example, the display mode engine(s) 210 may determine display attribute(s) 316 corresponding to the display properties of the first sub-element 106 and the second sub-element 108, and accordingly rotate the rotatable component 104. The rotatable component 104 may be rotated so that one of the first sub-element 106 and the second sub-element 108 may be positioned towards the screen 208.

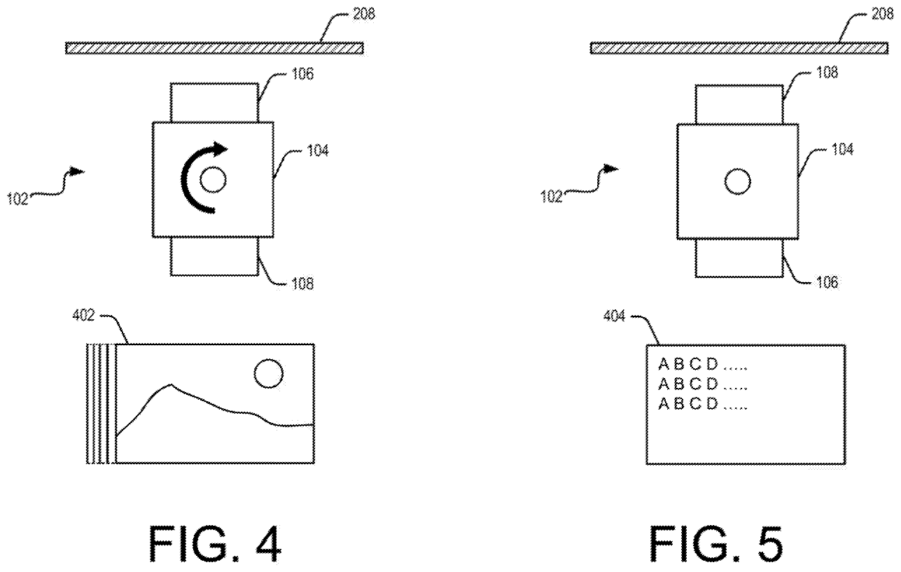

FIGS. 4-5 illustrate the manner in which the display mode engine(s) 210 controls and rotates the display element(s) 102. FIG. 4 illustrates an example display element(s) 102. The display element(s) 102 includes rotatable component 104. The rotatable component 104 further includes the first sub-element 106 and the second sub-element 108. In the present example, the first sub-element 106 may be considered as any sub-element which may be capable of rendering visual content which may use high-refresh rate, such as a video stream. The first sub-element 106 may be a sub-element of a volatile display, whereas the second sub-element 108 may be a sub-element of a static display. Examples of a volatile display includes, but is not limited to, liquid crystal displays (LCD), light emitting diode (LED) based displays, and organic light-emitting diode (OLED) based displays. On the other hand, examples of static displays include, but are not limited to, electrophoretic displays (EPD), cholesteric LCD displays, and interferometric modulator displays (IMOD). It is to be noted that the present examples of the first sub-element 106 and the second sub-element 108 are illustrative. These should not be construed as limiting the scope of the present subject matter. Other examples may also be implemented without deviating from the scope of the present subject matter.

Returning to the operation of the electronic device(s) 202, the display mode engine(s) 210 may detect a signal corresponding to visual content to be rendered. In one example, the signal could correspond to a video stream (as depicted by input signal 402). As is understood, displaying video content involves rendering the video frame at a high refresh rate. In one example, a high-refresh rate may be considered as refresh rate greater than about 60 Hz. The display mode engine(s) 210 may determine display attribute(s) 316 corresponding to the input signal 402. The display attribute(s) 316 may be considered as any property or attribute of the visual content (i.e., the visual content corresponding to the input signal 402) to be rendered on the display(s) 204 of the electronic device(s) 202. For example, for video based visual content, the display attribute(s) 316 may indicate a certain value indicative of a high-refresh rate.

On determining the display attribute(s) 316 of the input signal 402, e.g., the high-refresh rate, the display mode engine(s) 210 may further determine the display properties of the first sub-element 106 and the second sub-element 108. In the present example, the display mode engine(s) 210 may ascertain the first sub-element 106 may be used for rendering the visual content. Subsequently, the display mode engine(s) 210 may generate control instruction(s) 318. The control instruction(s) 318 once executed, affect the rotation of the rotatable component 104. The rotatable component 104 may be rotated such that the first sub-element 106 (i.e., the sub-element for high-refresh rates) may be positioned towards the display screen 208 of the display(s) 204. In the manner as described above, for each of the display element(s) 102, the first sub-element 106 may be positioned to face the display screen 208 (FIG. 4).

Once all the first sub-element 106 of each of the display element(s) 102 are positioned to face the display screen 208, the rendering engine(s) 310 may activate the first sub-element 106 of all the display element(s) 102 to render the visual content. In one example, the rendering engine(s) 310 may control color and brightness of each of the first sub-element 106 of all the display element(s) 102 to render the image(s) corresponding to the visual content, on the display(s) 204.

In a similar manner, the display mode engine(s) 210 may also detect an input signal 404 which may correspond to visual content to be rendered using a low-refresh rate. As would be understood, visual content such as text, static images, or content being displayed on an electronic book may not rely on high-refresh rate. In such a case, the display mode engine(s) 210 may determine the display attribute(s) 316 of the input signal 404. The display attribute(s) 316, in the present example, may indicate that visual content may be rendered using low-refresh rate values. Once the display attribute(s) 316 is determined, the display mode engine(s) 210 may identify the second sub-element 108 as the appropriate sub-element for rendering the visual content corresponding to the input signal 404. The display mode engine(s) 210 may generate another set of control instruction(s) 318. The control instruction(s) 318 when executed may rotate the rotatable component 104 such that the second sub-element 108 are positioned towards the display screen 208 of the display(s) 204.

Once the second sub-element 108 is positioned towards the display screen 208, the rendering engine(s) 310 may active the second sub-element 108 of all the display element(s) 102, to render the visual content corresponding to the input signal 404. Display elements rendering visual content using low-refresh rates generally utilize less power when compared with the visual content being displayed using high-refresh rates. The electronic device(s) 202 on other hand, may rely on the first sub-element 106 for rendering one type of content, while the second sub-element 108 may be utilized for rendering other type of content. Since the first sub-element 106 are not used all the time, the effective power utilization of the electronic device(s) 202 is likely to reduce. For example, video content would be displayed through the first sub-element 106 of ail the display element(s) 102. On other hand, text-based content may be rendered using the second sub-element 108.

It is to be noted that the example explained in conjunction with FIGS. 4-5 are exemplary. Other sub-elements with other display properties may also be used while still falling within the scope of the present subject matter. Furthermore, the rotatable component 104 is depicted as being provided with the first sub-element 106 and the second sub-element 108. The rotatable component 104 may be further provided with additional sub-elements. Such additional sub-elements may have display properties which are different from the display properties of the first sub-element 106 and the second sub-element 108. In one such example, an additional sub-element may be such that it provides a uniform color background when the display screen 208 of the display(s) 204 is powered off or in case where there is no display signal (e.g., the input signal 402 and input signal 404). In such a case, the display mode engine(s) 210 on determining that no signal is presently available, may rotate the rotatable component 104 to position the additional sub-element towards the display screen 208. In the example when no signal is available for the display(s) 204, a uniform color background may be provided. This consequently may reduce the power consumption when the display(s) 204 is not being provided with any input signal.

It may also be the case that the display screen 208 of the display(s) 204 is utilized for rendering a composite visual content. As a result, one portion of the display screen 208 is utilized for rendering one type of content, while the another portion of the display screen 208 is utilized for rendering another type of content. For instance, a portion of the display screen 208 is being used for displaying textual content, whereas the remainder of the screen is used for displaying video content. In one example, the composite visual content may be rendered as Picture-in-Picture (PiP) content, with one smaller portion of the display screen 208 rendering content in a smaller sized window, while the other content being provided within the main window.

As explained, text-based content may be rendered using low-refresh rate. In one example, the position engine(s) 312 may determine the position coordinate of the portion of the screen displaying textual content. In one example, the position engine(s) 312 may determine the position coordinates of the portion of the display screen 208 rendering the textual content. The position coordinates thus determined, are subsequently obtained by the display mode engine(s) 210. The display mode engine(s) 210 on obtaining the position coordinates may generate control instructions for a set of display element(s) 102. The location of the set of the display element(s) 102 is such, which correspond to the portion of the display screen 208 rendering textual content.

The control instruction for the set of display element(s) 102 when executed are such that the display element(s) 102 corresponding to the portion of the display screen 208 rendering the textual content, are rotated. In the present example, for each of the set of display element(s) 102, the second sub-element 108 are rotated such that they are positioned towards the display screen 208. In the manner described above, portions of the display screen 208 may be selectively controller for rendering certain type of contents. Although the present example is described in the context of refresh rates, any other first sub-element 106 and the second sub-element 108 having different type of display properties may be used without deviating from the scope of the present subject matter.

The rotatable component 104 may be of a variety of shapes and configurations. The examples as illustrated depict that the rotatable component 104 may be cube or cuboidal in shape. In such cases, the rotatable component 104 may accommodate other sub-elements in addition to the first sub-element 106 and the second sub-element 108. In another example, the rotatable component 104 may have a triangular cross-section. In such a case, the rotatable component 104 may be provided with about three sub-elements. It may be noted that the rotatable component 104 may be of any cross-section shape such that any desired number of sub-elements may be provided onto the rotatable component 104.

As described in relation to FIGS. 4-5, the electronic device(s) 202 may be used for rendering visual content with different refresh rate utilizations. In one example, the rotatable component 104 may be provided with sub-elements providing varying degrees of privacy. In such cases, any visual output display (e.g., the display(s) 204) may display content such that it is visible from either a wide-viewing angle, or from sets of narrower viewing angles. In such cases, a user not intending to view visual content privately may select a viewing mode which allows the visual content to be viewed from wide-viewing angle. As a result, the visual content being displayed may be visible from a multitude of direction to any individual present within the vicinity of the visual output display. In other cases, where privacy in viewing the visual content to the exclusion of other is desired, the visual output display may display the visual content such that it is visible within a limited viewing angle with respect to the visual output display.

A viewing angle may be considered as a maximum angle at which a display can be viewed with the desired visual performance. The viewing angle may be denoted through a notional cone, the vertex of which lies in a plane in which the display screen of a visual output display exists. The axis of the cone may extend perpendicular to the plane of the display screen. Generally, visual content being rendered on a visual output display is observation from any point of observation present within the viewing cone. The angle formed at the vertex of the viewing cone determines whether the visual content is viewable from a number of positions with respect to the visual output display. If the value of the angle is high or more, the visual output display may be considered as having a wide-viewing angle. On the other hand, if the angle at the vertex of the viewing cone is less or lower, then the visual output display may be considered as having a narrow-viewing angle.

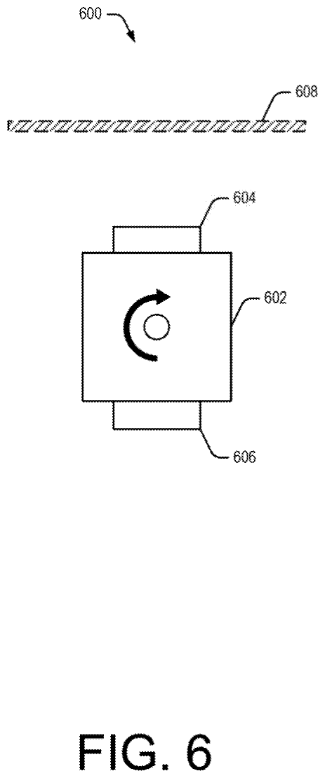

FIG. 6 illustrates a visual output display 600 which allows for viewing visual content in a normal mode and a privacy mode. In a normal mode, the visual content displayed on a screen 608 of the visual output display 600 is visible from different positions in the vicinity of the display 600. In the privacy mode, the visual content may be visible from certain specific positions with respect to the display 600. To this end, the display 600 may include a rotatable component 602. The rotatable component 602 is similar to the rotatable component 104, as discussed in conjunction with the FIGS. 1-5. The display 600 on the other hand, may include a plurality of rotatable component(s) 602 arranged in an array (not shown in FIG. 6). The array of the rotatable component 602 may extend along the plane in which the display 600 extends. In the present example, the rotatable component 602 is further provided with a wide-viewing sub-element 604, and a privacy sub-element 606. The wide-viewing sub-element 604 renders the visual content such that it is visible from a wide-viewing angle. In such a case, the content is visible from multiple directions or vantage points with respect to the display 600. On the other hand, visual content rendered using privacy sub-element 606 is so rendered, such that it is visible when viewed from a small viewing angle with respect to the display 600, such that the content is visible from a first viewing angle, with the first viewing angle being narrower or less than the wide-viewing angle.

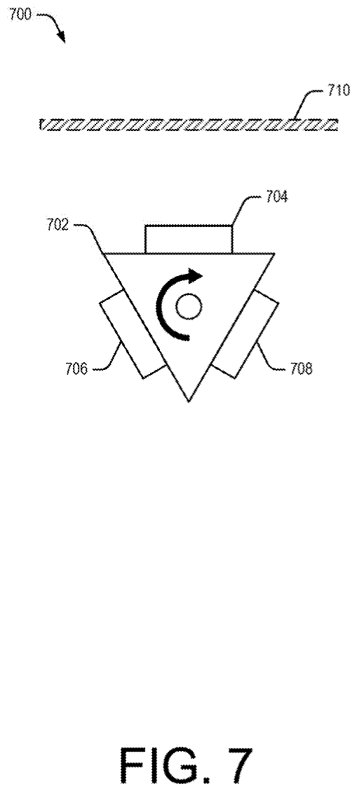

These and other aspects are further described with respect to FIG. 7 which illustrates a visual output display 700 for viewing visual content in a normal mode and a number of privacy modes. In such an example, the visual content may be visible from specific positions with respect to the display 700. The display 700 may include rotatable component 702. The rotatable component 702 is similar to the rotatable component 104, as discussed in conjunction with the FIGS. 1-5. The display 700 may include a plurality of rotatable components 702 arranged in an array (not shown in FIG. 7). The array of the rotatable component 702 may extend along the plane in which the display 700 extends.

In the present example, the rotatable component 702 is further provided with a wide viewing sub-element 704, and additional privacy sub-elements 706 and 708. The wide viewing sub-element 704 (referred to as the sub-element 704) is a sub-element which when activated, radiate light in a dispersed manner such that the viewing angle centered at the wide viewing sub-element 704, is large. The privacy sub-elements 706 and 708 may further be used for viewing visual content in two differing modes of privacy. Each of the privacy sub-elements 706 and 708 may allow different viewing angles, and consequently, different modes of privacy. In the present example, the resulting viewing angle corresponding to the sub-element 706 (referred to as a first viewing angle) may be less than the resulting wide-viewing angle of the sub-element 704, but greater than the corresponding second viewing angle of the sub-element 708.

In the present example, the display 700 may either be integrated within an electronic device (such as in the case of mobile phones) or may be implemented as stand-alone displays that may be connected to a computing device. The rotatable component 702 within the display 700 may be rotated such that any one of the sub-element 704, 706, and 708 may be positioned to face screen 710 of the display 700.

The rotation of the rotatable component 702 may be affected by a component, such as the display mode engine(s) 210. In one example, the display mode engine(s) 210 may determine a privacy setting for the display 700. The privacy setting may be based on the visual content being rendered on the display 700 or based on a user-input. In one example, the privacy setting may indicate that the visual content may be viewed without privacy concerns. In such a case, the display mode engine(s) 210 may generate control instruction which executed affect the rotation of the rotatable component 702. The rotatable component 104 may be rotated such that the sub-element 704 is positioned to face the screen 710 of the display 700.

Continuing with the present example, the privacy setting may indicate that the visual content is to be viewed privately. In this case, the display mode engine(s) 210 may, based on the privacy setting, generate control instruction for positioning the sub-element 706 towards the screen 710. The sub-element 706, may render the visual content such that the viewing angle is less in comparison with the viewing angle for the sub-element 704. In a case where the user desires further privacy, the rotatable component 104 may be so rotated such that the sub-element 708 may be positioned towards the screen 710. With the sub-element 706 being positioned to face the screen 710, the corresponding viewing angle is the least. Consequently, the visual content being rendered on the display 700 would be such that it is viewable from points of observation within the narrow viewing angle. In the manner as described above, the display 700 may be adjusted to render visual content with varying levels of privacy.

Although examples for the present disclosure have been described in language specific to structural features and/or methods, it may be understood that the appended claims are not necessarily limited to the specific features or methods described. Rather, the specific features and methods are disclosed and explained as examples of the present disclosure.

1. An electronic display comprising:
a display element corresponding to a pixel of the electronic display, the display element comprising:
a rotatable component; and
a first sub-element and a second sub-element, wherein the first sub-element and the second sub-element are provided on the rotatable component, with the first sub-element and the second sub-element having different display properties.

2. The electronic display as claimed in claim 1, wherein the rotatable component is to rotate to position one of the first sub-element and the second sub-element facing a screen of the electronic display, based on a display attribute of a visual content to be rendered onto the screen.

3. The electronic display as claimed in claim 2, wherein the rotatable component is rotatable about an axis parallel to the screen of the electronic display.

4 The electronic display as claimed in claim 1, wherein the display properties is one of high refresh rate, low refresh rate, and angle of viewing.

5. The electronic display as claimed in claim 1, wherein the rotatable component is coupled to a microelectromechanical-based drive.

6. The electronic display as claimed in claim 1, wherein the first sub-element is angularly displaced with respect to the second sub-element with respect to an axis about which the rotatable component is to rotate.

7. The electronic display as claimed in claim 1, wherein the first sub-element is positioned diametrically opposite to the second sub-element on the rotatable component.

8. An electronic device comprising:
a display having a display screen;
an array of display elements corresponding to pixels extending in parallel to the display screen, with each display element comprising:
a rotatable component; and
a first sub-element and a second sub-element, provided on the rotatable component, with the first sub-element and the second sub-element having different display properties; and
a display mode engine in communication with the rotatable component, wherein the display mode engine is to:
generate control instructions, which when executed affect rotation of the rotatable component to position one of the first sub-element and the second sub-element towards the display screen based on a display attribute,

9. The electronic claim as claimed in claim 8, wherein the display mode engine is to further:
determine the display attribute based on a visual content being rendered on the display screen;
ascertain a display property based on the determined display attribute; and
for the display element, identify one of the first sub-element and the second sub-element corresponding to the display property.

10. The electronic device as claimed in claim 8, wherein the rotatable component comprises a microelectromechanical-based drive.

11. The electronic device as claimed in claim 8, wherein for a visual content further comprising a first content and a second content rendered in a first portion and a second portion of the display screen, respectively, the display mode engine is to further:
ascertain a first display attribute corresponding to the first content;
ascertain a second display attribute corresponding to the second content;
evaluate the first display attribute to be compatible with the first sub-element and the second display attribute to be compatible with the second sub-element;
based on the evaluating, affect rotation of the rotatable component, wherein on rotation:
the first sub-elements corresponding to the first portion, are positioned towards the display screen, and
the second sub-elements corresponding to the second portions are positioned towards the display screen.

12. The electronic device as claimed in claim 11, wherein one of the first display attribute and the second display attribute comprises one of a high refresh rate and a low refresh rate, respectively.

13. A visual output display comprising
a display element corresponding to a pixel of the visual output display, the display element comprising:
a rotatable component; and
a wide viewing sub-element and a privacy sub-element provided on the rotatable component, with the wide viewing sub-element is to render content viewable with a wide-viewing angle and the privacy sub-element is to render content viewable from a first viewing angle, wherein the first viewing angle is less than the wide-viewing angle.

14. The visual output display as claimed in claim 13, wherein the rotatable component includes additional privacy sub-elements to render content viewable from a second viewing angle, wherein the second viewing angle is different from the first viewing angle.

15. The visual output display as claimed in claim 13, wherein the rotatable component is rotatable to position one of the wide viewing sub-element and the privacy sub-element based on a user input, towards a screen of the display.
